(19) United States
(12) Patent Application Publication
(10) Pub. No.: US 2026/0119673 A1
(43) Pub. Date: Apr. 30, 2026

(54) Framework To Actively Scan The Source Code For Evil Regex To Prevent REDOS Attacks

(71) Applicant: Dell Products L.P., Round Rock, TX (US)

(72) Inventors: Parminder Singh Sethi, Punjab (IN); Anay Kishore, Bangalore (IN); Praveen Kumar, Noida (IN)

(73) Assignee: Dell Products L.P., Round Rock, TX (US)

(21) Appl. No.: 18/930,329

(22) Filed: Oct. 29, 2024

(51) Int. Cl. G06F 21/57

(52) U.S. Cl. CPC G06F 21/577; G06F 2221/034

(57) ABSTRACT

Methods, system, and non-transitory processor-readable storage medium for regex engine system are provided herein. An example method includes a Continuous Integration/Continuous Delivery (CI/CD) pipeline that triggers a regex engine system to scan source code. The regex engine system scans the source code for a plurality of regular expressions, and determines a regular expression vulnerability assessment associated with the plurality of regular expressions. The regex engine system generates a regular expression vulnerability assessment report comprising the regular expression vulnerability assessment.

### FIELD

The field relates generally to detecting evil regex in source code to prevent regex Denial of Service attacks.

### BACKGROUND

Regular expressions are often found in source code. A regular expression is a pattern that matches strings or portions of strings in the source code.

### SUMMARY

Illustrative embodiments provide techniques for implementing a regex engine system in a storage system. For example, in illustrative embodiments a Continuous Integration/Continuous Delivery (CI/CD) pipeline triggers a regex engine system to scan source code. The regex engine system scans the source code for a plurality of regular expressions, and determines a regular expression vulnerability assessment associated with the plurality of regular expressions. The regex engine system generates a regular expression vulnerability assessment report comprising the regular expression vulnerability assessment. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a regex engine system, in an illustrative embodiment.

FIG. 2 shows a regex engine system, in an illustrative embodiment.

FIG. 3 shows an example of the regex engine system architecture, in an illustrative embodiment.

FIG. 4 shows a flow diagram of a process for a regex engine system, in an illustrative embodiment.

FIG. 5 illustrates an example CI/CD pipeline system employing the regex engine system as a stage within the CI/CI pipeline system, in an illustrative embodiment.

FIG. 6 illustrates an example verification of whether both a valid and invalid email format are correctly processed by a regular expression in an illustrative embodiment.

FIG. 7 illustrates an example verification of an evil regular expression in an illustrative embodiment.

FIG. 8 illustrates an example regex analyzer report produced by the regex engine system, in an example embodiment.

FIGS. 9 and 10 show examples of processing platforms that may be utilized to implement at least a portion of a regex engine system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a regex engine system, which technique may be used to scan source code for evil regex where a Continuous Integration/Continuous Delivery (CI/CD) pipeline triggers a regex engine system to scan source code. The regex engine system scans the source code for a plurality of regular expressions, and determines a regular expression vulnerability assessment associated with the plurality of regular expressions. The regex engine system generates a regular expression vulnerability assessment report comprising the regular expression vulnerability assessment.

Regular expressions are required for both business and application needs. To understand the underlying vulnerabilities and risks, developers need to identify the potential challenges that might occur when regular expressions are used in source code. When source code contains regular expressions, during execution of that source code, a certain amount of time is required to validate any input against the regular expression. In some cases, the validation of an input via a regular expression goes to an extreme condition and utilizes all possible paths. This scenario may result in the validation taking a long time. If an attacker can push the system to a state where a huge amount of input is provided for the system to validate one or more regular expressions, the system may enter into an extreme situation of multiple paths and catastrophic backtracking. A regular expression that exhibits catastrophic backtracking is considered to be an “evil regex”. All the system resources may be consumed by this effort and the system will not be able to take any new requests. This is one example of a Denial of Service (DoS) attack. If a regular expression is used in source code without fulling understanding the background working of a regular expression, there is a high probability of including an evil regular expression (i.e., an evil regex) in the source code of an application. Thus, it is very important to track these vulnerabilities and threats during the development cycle of an application. Even source code without an evil regex can be attacked; this can impact the performance of services and applications, for example, forcing a regular expression validation to execute the worst-case scenario during each validation. Conventional technologies don't continually scan source code to find the implemented regular expression and evil regular expressions. Conventional technologies don't validate regular expressions to ensure proper implementation of the regular expressions in source code.

Conventional technologies don't capture information regarding the amount of damage that can be done with a given regular expression. Conventional technologies don't provide a framework to identify evil regular expressions in source code that has been recently checked into a CI/CD pipeline system, where the framework performs a deep search and analyzes various design patterns to understand the threat that evil regular expressions can cause. Conventional technologies don't provide a method to auto-generate sample inputs for testing the regular expressions for fast fail approach using boundary value analysis techniques. Conventional technologies don't use machine learning to auto generate the sample inputs for testing the regular expressions. Conventional technologies don't provide a tool that pre-empts regular expression Denial of Service (REDOS) attacks.

By contrast, in at least some implementations in accordance with the current technique as described herein, REDOS attacks are prevented by detecting evil regex in source code by a Continuous Integration/Continuous Delivery (CI/CD) pipeline that triggers a regex engine system to scan source code. The regex engine system scans the source code for a plurality of regular expressions, and determines a regular expression vulnerability assessment associated with the plurality of regular expressions. The regex engine system generates a regular expression vulnerability assessment report comprising the regular expression vulnerability assessment.

Thus, a goal of the current technique is to provide a method and a system for providing a regex engine system that identifies evil regular expressions. Another goal is to continually scan source code to find the implemented regular expression and evil regular expressions. Another goal is to validate regular expressions to ensure proper implementation of the regular expressions in source code. Another goal is to capture information regarding the amount of damage that can be done with a given regular expression. Another goal is to provide a framework to identify evil regular expressions in source code that has been recently checked into a CI/CD pipeline system, where the framework performs a deep search and analyzes various design patterns to understand the threat that evil regular expressions can cause. Another goal is to provide a method to auto-generate sample inputs for testing the regular expressions for fast fail approach using boundary value analysis techniques. Another goal is to use machine learning to auto generate the sample inputs for testing the regular expressions. Yet another goal is to provide a tool that pre-empts regular expression Denial of Service (REDOS) attacks.

In at least some implementations in accordance with the current technique described herein, the use of a regex engine system can provide one or more of the following advantages: providing a method and a system for providing a regex engine system that identifies evil regular expressions, continually scanning source code to find the implemented regular expression and evil regular expressions, validating regular expressions to ensure proper implementation of the regular expressions in source code, capturing information regarding the amount of damage that can be done with a given regular expression, providing a framework to identify evil regular expressions in source code that has been recently checked into a CI/CD pipeline system, where the framework performs a deep search and analyzes various design patterns to understand the threat that evil regular expressions can cause, providing a method to auto-generate sample inputs for testing the regular expressions for fast fail approach using boundary value analysis technique, using machine learning to auto generate the sample inputs for testing the regular expressions, and providing a tool that pre-empts regular expression Denial of Service (REDOS) attacks.

In contrast to conventional technologies, in at least some implementations in accordance with the current technique as described herein, REDOS attacks are prevented by detecting evil regex in source code by a Continuous Integration/Continuous Delivery (CI/CD) pipeline that triggers a regex engine system to scan source code. The regex engine system scans the source code for a plurality of regular expressions, and determines a regular expression vulnerability assessment associated with the plurality of regular expressions. The regex engine system generates a regular expression vulnerability assessment report comprising the regular expression vulnerability assessment.

In an example embodiment of the current technique, the regex engine system transmits the source code to a build stage in the CI/CD pipeline.

In an example embodiment of the current technique, the regex engine system receives the source code from a source code repository associated with the CI/CD pipeline.

In an example embodiment of the current technique, a collector module compiles source code information, from a source code repository, to identify the source code to be scanned by the regex engine system, where the regex engine system comprises the collector module.

In an example embodiment of the current technique, a search engine scans the source code to identify the plurality of regular expressions in the source code, where the regex engine system comprises the search engine.

In an example embodiment of the current technique, a knowledge lake receives scanning requirements for the source code, where the regex engine system comprising the knowledge lake.

In an example embodiment of the current technique, the knowledge lake comprises information about regular expressions identified in previously scanned source code.

In an example embodiment of the current technique, a test input generator receives, from the knowledge lake, information about regular expressions identified in previously scanned source code.

In an example embodiment of the current technique, a test input generator transmits to the knowledge lake, regular expression test inputs with which to validate the plurality of regular expressions for the regular expression vulnerability assessment, where the test input generator generates the test inputs based on machine learning inputs from a learning engine, where the regex engine system comprises the test input generator and the learning engine.

In an example embodiment of the current technique, for each regular expression in the plurality of regular expressions, the test input generator generates at least one set of passing test inputs for each regular expression that match regular expression validation criteria, where at least one set of passing test inputs, when applied to each regular expression pass the regular expression validation criteria, the test input generator generates at least one set of failing test inputs for each regular expression that match the regular expression validation criteria, where at least one set of failing test inputs, when applied to each regular expression fail the regular expression validation criteria, and the test input generator generates at least one set of boundary test inputs for each regular expression that match the regular expression validation criteria, where at least one set of boundary test inputs, when applied to each regular expression signal a potential catastrophic failure according to the regular expression validation criteria.

In an example embodiment of the current technique, the learning engine compiles regular expression data from the plurality of regular expressions and regular expression vulnerabilities associated with the plurality of regular expressions.

In an example embodiment of the current technique, the regex engine system identifies, as part of the regular expression vulnerability assessment, that at least one of the plurality of regular expressions comprises infinite backtracking.

In an example embodiment of the current technique, an intelligent analyzer module validates the plurality of regular expressions using regular expression test inputs provided by a test input generator module, where the regex engine system comprises the intelligent analyzer module and the test input generator module.

In an example embodiment of the current technique, the intelligent analyzer module prioritizes the regular expression test inputs to detect fast-fail regular expression test inputs, where the intelligent analyzer module employs a conformal prediction machine learning model.

In an example embodiment of the current technique, for each regular expression in the plurality of regular expressions the intelligent analyzer module applies at least one set of passing test inputs, at least one set of failing test inputs to each regular expression, and at least one set of boundary test inputs to each regular expression, and transmits results of at least one of the applying passing test inputs, failing test inputs and boundary test inputs to the decision maker module.

In an example embodiment of the current technique, the regex engine system determines a degree of deviation from a regular expression execution time for a subset of the plurality of regular expressions.

In an example embodiment of the current technique, a decision maker module receives outputs from the intelligent analyzer module, and determines the regular expression vulnerability assessment associated with the plurality of regular expressions based on the outputs, using policies applied to the outputs.

In an example embodiment of the current technique, the decision maker module determines that at least one of the plurality of regular expressions is vulnerable to a denial of service attack and provides at least one of the plurality of regular expressions with a failed regular expression vulnerability assessment.

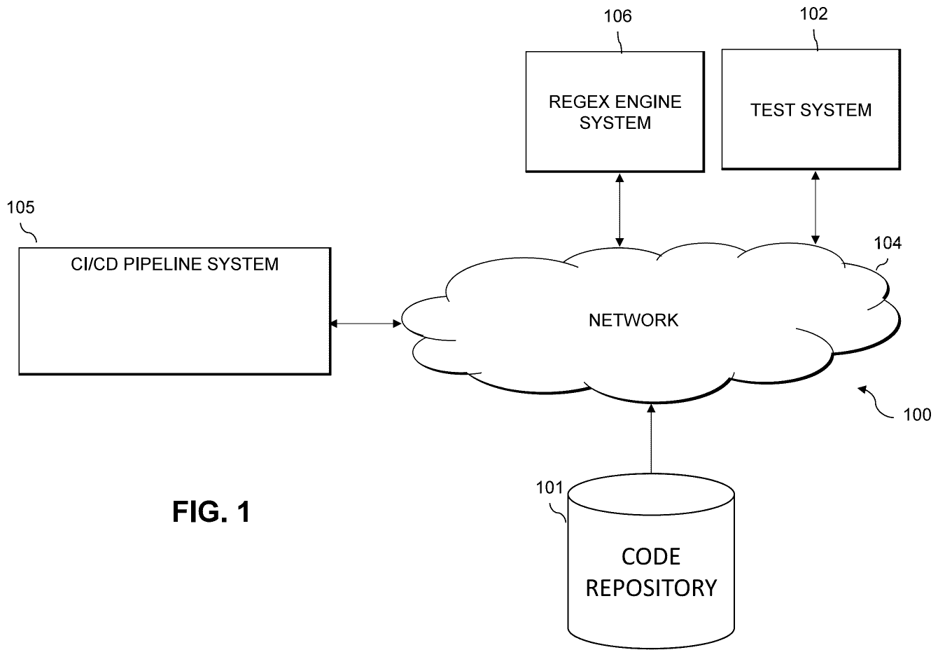

FIG. 1 shows a computer network (also referred to herein as an information processing system) 100 configured in accordance with an illustrative embodiment. The computer network 100 comprises a Continuous Integration/Continuous Delivery (CI/CD) pipeline system 105, a regex engine system 106, test system 102, and a code repository 101. In an example embodiment, CI/CD as that term is used herein, refers generally to continuous integration, continuous deployment and/or continuous delivery. Such functions or portions thereof are considered to be examples of a “software development process” as that term is broadly used herein. A wide variety of other types of software development processes may be utilized in other embodiments, illustratively relating to integration, deployment and/or other aspects of software development for one or more of the source code that is executed on other systems, for example, on the test system 102. The CI/CD pipeline system 105, test system 102, regex engine system 106, and code repository 101 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a regex engine system 106 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the CI/CD pipeline system 105, test system 102, regex engine system 106, and code repository 101 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The CI/CD pipeline system 105, test system 102, regex engine system 106, and code repository 101 in some embodiments comprise respective computers associated with a particular company, organization or other enterprise. In addition, at least portions of the computer network 100 may also be referred to herein as collectively comprising an “enterprise network. ” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the regex engine system 106 are one or more input-output devices, which illustratively comprise keyboards, displays or other types of input-output devices in any combination. Such input-output devices can be used, for example, to support one or more user interfaces to the regex engine system 106, as well as to support communication between the regex engine system 106 and other related systems and devices not explicitly shown. For example, a dashboard may be provided for a user to view a progression of the execution of the regex engine system 106. One or more input-output devices may also be associated with any of the CI/CD pipeline system 105, test system 102, regex engine system 106, and code repository 101.

Additionally, the regex engine system 106 in the FIG. 1 embodiment is assumed to be implemented using at least one processing device. Each such processing device generally comprises at least one processor and an associated memory, and implements one or more functional modules for controlling certain features of the regex engine system 106.

More particularly, the regex engine system 106 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture”as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the regex engine system 106 to communicate over the network 104 with the CI/CD pipeline system 105, test system 102, regex engine system 106, and code repository 101 and illustratively comprises one or more conventional transceivers.

A regex engine system 106 may be implemented at least in part in the form of software that is stored in memory and executed by a processor, and may reside in any processing device. The regex engine system 106 may be a standalone plugin that may be included within a processing device.

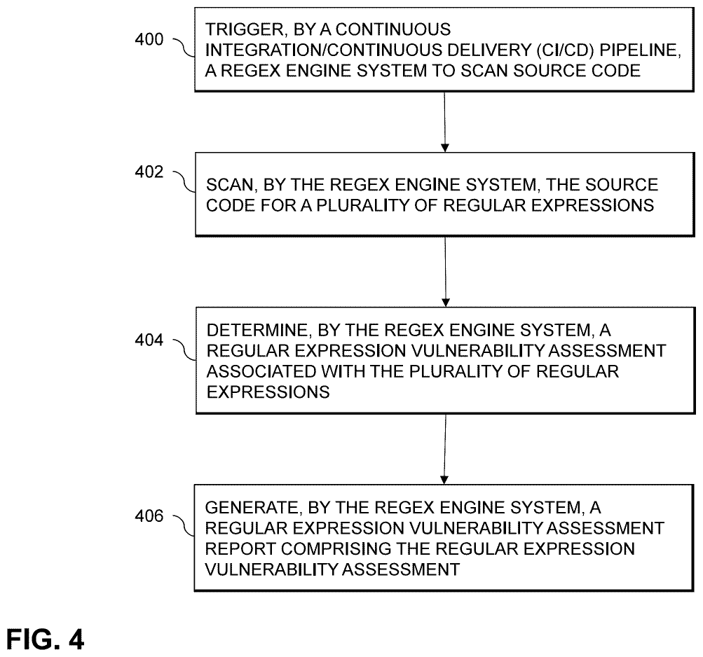

It is to be understood that the particular set of elements shown in FIG. 1 for regex engine system 106 involving the CI/CD pipeline system 105, test system 102, regex engine system 106, and code repository 101 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the regex engine system 106 can be on and/or part of the same processing platform. An exemplary process of regex engine system 106 in computer network 100 will be described in more detail with reference to, for example, the flow diagram of FIG. 4.

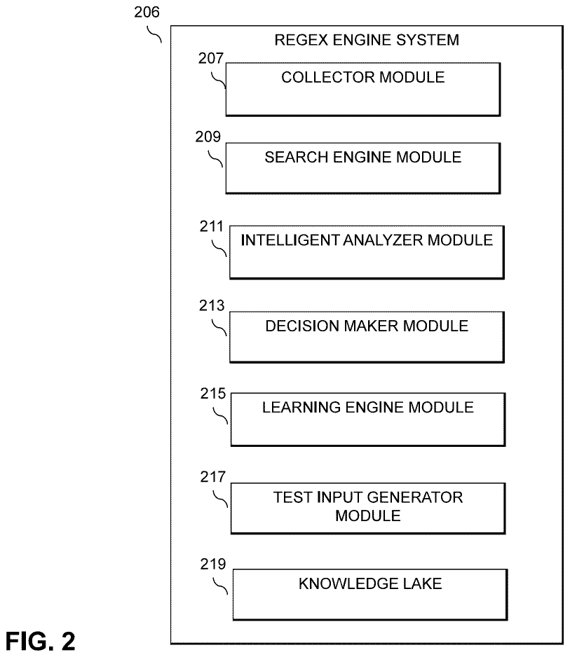

FIG. 2 illustrates a regex engine system 206 comprising a collector module 207, a search engine module 209, an intelligent analyzer module 211, a decision maker module 213, a learning engine module 215, a test input generator module 217, and a knowledge lake 219. Each of these modules will be explained in further details below.

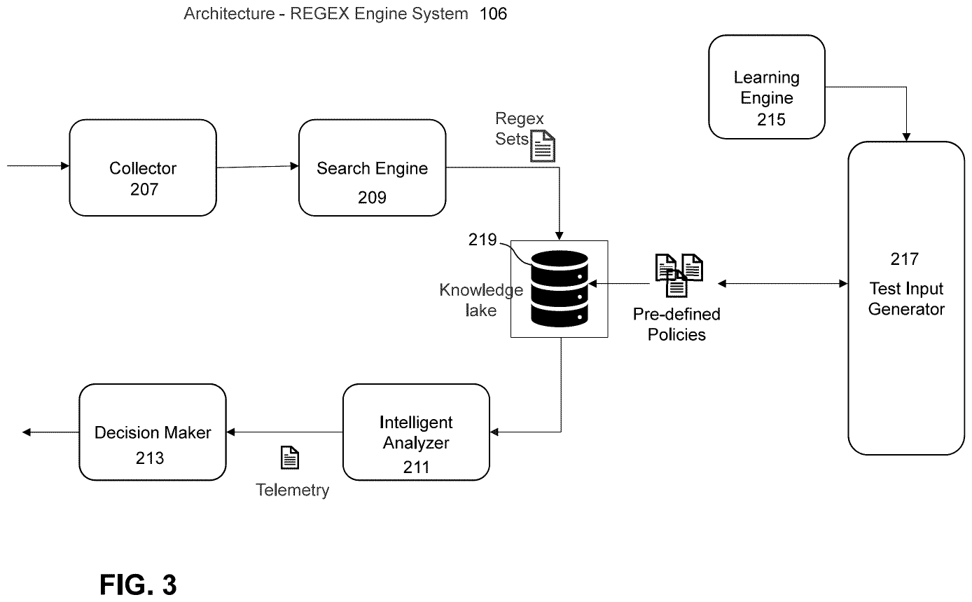

FIG. 3 is an example of the regex engine system 106 architecture comprising a collector module 207, a search engine module 209, an intelligent analyzer module 211, a decision maker module 213, a learning engine module 215, a test input generator module 217, and a knowledge lake 219. These components will be discussed in further detail below.

FIG. 4 is a flow diagram of a process for execution of the regex engine system 106 in an illustrative embodiment. It is to be understood that this particular process is only an example, and additional or alternative processes can be carried out in other embodiments.

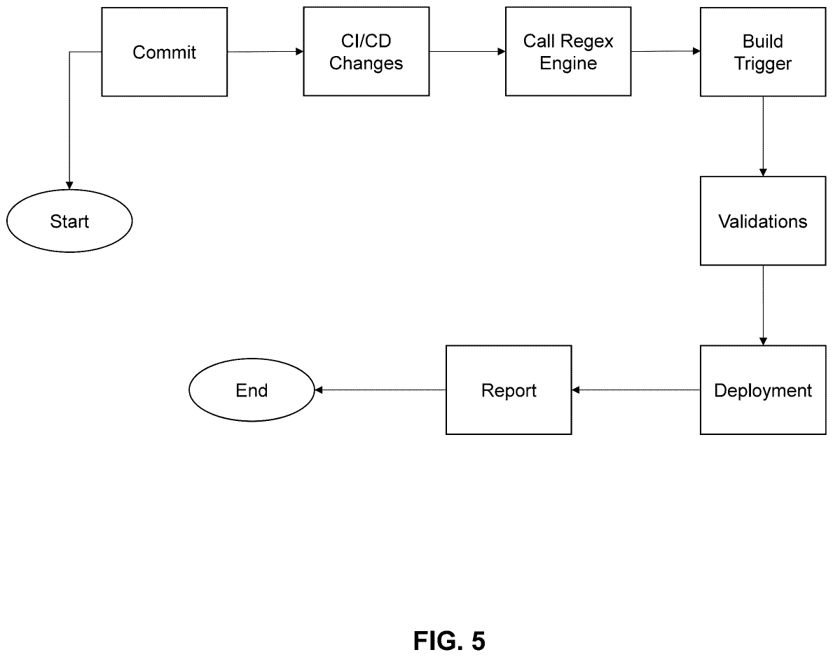

At 400, a CI/CD pipeline runner system 105 triggers the regex engine system 106 to scan source code. For example, the regex engine system 106, and in particular a scan service associated with the regex engine system 106, may be incorporated into the CI/CD pipeline system 105 as a stage within the CI/CD pipeline system 105. FIG. 5 illustrates an example CI/CD pipeline system 105 employing the regex engine system 106 as a stage within the CI/CD pipeline system 105.

In an example embodiment, a script may trigger the scan service. In an example embodiment, as source code is created and/or updated, it is committed to a source code repository 101, such as Gitlab. As part of the CI/CD pipeline system 105, the scan service is called to scan new code committed to the source code repository 101. In an example embodiment, developers may call the regex engine system 106's scan Application Programming Interface (API). Further any number of developers may call the scan API in parallel. In an example embodiment, the regex engine system 106 receives the source code from the source code repository 101 associated with the CI/CD pipeline system 105.

At 402, the regex engine system 106 scans the source code for a plurality of regular expressions. In an example embodiment, a collector module 207 compiles source code information, from the source code repository 101 to identify the source code to be scanned by the regex engine system 106. In an example embodiment, the collector module 207 collects details of the source code that must be scanned for regular expressions. In an example embodiment, the CI/CD pipeline system 105 invokes the regex engine system 106, and in turn, the collector module 207 is activated. In an example embodiment, the search engine module 209 scans the source code to identify the plurality of regular expressions that are implemented within the source code. In an example embodiment, the knowledge lake 219 receives scanning requirements for the source code. In an example embodiment, the knowledge lake 219 comprises information about regular expressions identified in previously scanned source code, along with current scanning requirements for the source code. In an example embodiment, the knowledge lake 219 also receives inputs from the test input generator module 217 and the learning engine module 215. In an example embodiment, the test input generator module 217 receives information about regular expressions identified in previously scanned source code from the knowledge lake 219.

In an example embodiment, the test input generator module 217 transmits to the knowledge lake 219 regular expression test inputs with which to validate the plurality of regular expressions for the regular expression vulnerability assessment. The test input generator module 217 generates the test inputs based on machine learning inputs from the learning engine module 215. In an example embodiment, the test input generator module 217 generates the test inputs to be used for testing the regular expressions that have been identified by scanning the source code, based on machines learning inputs from the learning engine module 215, pre-defined policies, and the knowledge lake 219. In an example embodiment, the pre-defined policies are stored in the knowledge lake 219, and are used to determine whether the validation efforts are successes or failures. In an example embodiment, during configuration, administrators have an option to update the policies based on organizational benchmarks. In an example embodiment, the learning engine module 215 collects data about scanned regular expressions and related vulnerabilities. In an example embodiment, the learning engine module 215 receives inputs from local scan results and the Content Delivery Network (CDN) analyzer and a backend server. The learning engine module 215 aggregates regular expression data from the plurality of regular expressions and regular expression vulnerabilities associated with the plurality of regular expressions. In an example embodiment, the test input generator module 217 initially creates inputs based on the regular expression for happy path cases. Next, the test input generator module 217 creates an array of special characters, space characters, numbers, and alphabets. The test input generator module 217 then generates a second set of inputs based on the basic input structure identified for the regular expression. The test input generator module 217 then creates an array of special scenarios such as escape sequences, alternation back references, anchors, quantifiers, assertions, and edge cases, based on size patterns. All of these inputs are treated as possible inputs for validation of the regular expression. These inputs are stored as values in a dataset and passed to the intelligent analyzer module 211 for further processing.

In an example embodiment, the test input generator module 217 initially operates using basic principles of regular expression and then builds upon identified types of characters and special characters marked in the regular expression that are identified as part of the initial investigation of the source code.

In an example embodiment, for each regular expression in the plurality of regular expressions, the test input generator module 217 generates at least one set of passing test inputs for each regular expression, where the set of passing test inputs match regular expression validation criteria such that when the set of passing test inputs are applied to the regular expression, the regular expression passes the regular expression validation criteria. For example, if a given regular expression is /\hat{ }([a-zA-Z0-9._%-]+@[a-zA-Z0-9.-]+\.[a-zA-Z]{2,})$/, then a passing test input may be abcde@gmail.com.

In an example embodiment, for each regular expression in the plurality of regular expressions, the test input generator module 217 generates at least one set of failing test inputs for each regular expression, where the set of failing test inputs match regular expression validation criteria such that when the set of failing test inputs are applied to the regular expression, the regular expression fails the regular expression validation criteria. For example, if a given regular expression is /\hat{ }([a-zA-Z0-9._%-]+@[a-zA-Z0-9.-]+\.[a-zA-Z]{2,})$/, then a failing test input may be abcdgmail.com.

In an example embodiment, for each regular expression in the plurality of regular expressions, the test input generator module 217 generates at least one set of boundary test inputs for each regular expression, where the set of boundary test inputs match regular expression validation criteria such that when the set of boundary test inputs are applied to the regular expression, the regular expression signals a potential catastrophic failure according to the regular expression validation criteria. For example, if a given regular expression is /\hat{ }([a-zA-Z0-9._%-]+@[a-zA-Z0-9.-]+\.[a-zA-Z]{2,})$/, then a boundary test input may be abc.xyzMNO_01_PqR@gmail.com.

In an example embodiment, the test inputs generated by the test input generator module 217 are entry points for the intelligent analyzer module 211. The test input generator module 217 creates classes of input sets and starts a multi-threaded analysis and validation of the regex engine system 106. In an example embodiment, the number of test scenarios generated by the test input generator module 217 may vary depending on the regular expression. The test input generator module 217 may generate more test scenarios for one regular expression versus a different regular expression. For example, more input sets may be generated by the test input generator module 217 as the complexity of the regular expression increases. In other words, the test requirements, the number of resources, and the test required to complete the testing of any given regular expression is proportional to the complexity of the regular expression.

At 404, the regex engine system 106 determines a regular expression vulnerability assessment associated with the plurality of regular expressions. In an example embodiment, the regex engine system 106 identifies, as part of the regular expression vulnerability assessment, that at least one of the plurality of regular expressions comprises infinite backtracking. In an example embodiment, the intelligent analyzer module 211 validates the plurality of regular expressions using regular expression test inputs provided by a test input generator module 217. In an example embodiment, the intelligent analyzer module 211 performs the validation based on the regular expressions identified when the source code was scanned, along with inputs provided by the test input generator module 217. In an example embodiment, the intelligent analyzer module 211 prepares analysis inputs for the decision maker module 213, based on policies and validation output. In an example embodiment, the decision maker module 213 makes decisions whether the output of the test input generator module 217 should be deemed to be a success or failure, based on the pre-defined policies and inputs provided by the CDN analyzer. These inputs may comprise, but are not limited to timeouts, expected time, deviations, etc. In an example embodiment, the test input generator module 217 dynamically generates the test inputs and are passed onto the intelligent analyzer module 211 and the decision maker module 213. The intelligent analyzer module 211 applies the test inputs to the regular expressions and the decision maker module 213 makes the determination whether to treat a particular regular expression as an evil regular expression.

In an example embodiment, the intelligent analyzer module 211 prioritizes the regular expression test inputs to detect fast-fail regular expression test inputs. In an example embodiment, the intelligent analyzer module 211 employs a conformal prediction machine learning model. The regex engine system 106 analyzes the conformal output and prioritizes the test to detect the fast-fail regular expression test inputs. In an example embodiment, the regex engine system 106 comprises a pre-trained model to perform validation on at least some of the regular expressions and their related regular expression test inputs. In an example embodiment, the intelligent analyzer module 211 uses the conformal prediction machine learning model with happy path inputs to train the model for analysis of the regular expressions. The remaining data is then used as calibration input and to predict robustness. The intelligent analyzer module 211 also uses the remaining data for failure prediction in a fast-fail strategy, using the reverse significance method. For example, if the significance is 0.1%, then the possibility of a correct prediction is 90%. Thus, the time taken to perform a particular test in a regular expression plays a vital role in determining the character of the regular expression. Based on the pre-determined level of significance and the time factor, the intelligent analyzer module 211 determines of a given regular expression has a chance of failing against the set parameters, and whether that given regular expression will, therefore, be identified as an evil regular expression.

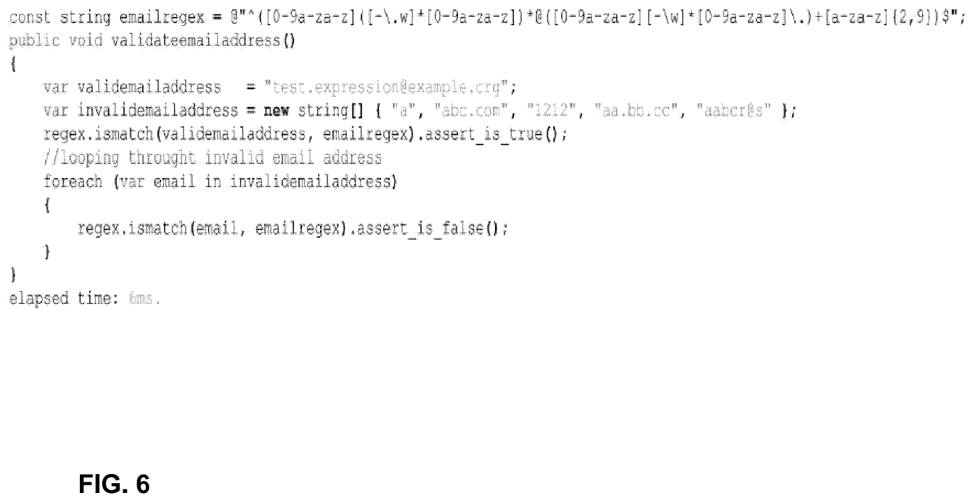

In an example embodiment, for each regular expression in the plurality of regular expressions, the intelligent analyzer module 211 applies at least one set of passing test inputs to each regular expression, the intelligent analyzer module 211 applies at least one set of failing test inputs to each regular expression, and the intelligent analyzer module 211 applies at least one set of boundary test inputs to each regular expression. The intelligent analyzer module 211 then transmits the results of applying the passing test inputs, the failing test inputs, and the boundary test inputs to the decision maker module 213. The expected results are determined based on internally stored policies and a knowledge base (for example, the results of the test inputs applied to the regular expressions and the expected time for the regular expression to process the test input). In an example embodiment, the regex engine system 106 determines a degree of deviation from a regular expression execution time for a subset of the plurality of regular expressions. For example, FIG. 6 illustrates an example verification of whether both a valid and invalid email format are correctly processed by a regular expression.

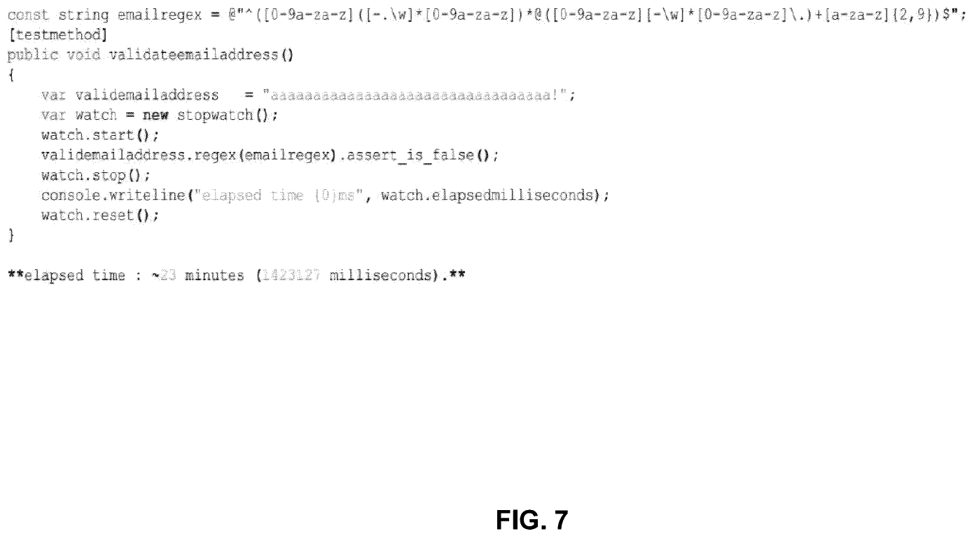

In another example embodiment, FIG. 7 illustrates an example verification of an evil regular expression in an illustrative embodiment. In this example embodiment, an arbitrary input of a varied length has caused the system to go into multiple loops of backtracking. This consumes an enormous amount of time to validate. This indicates a high possibility of failure if thousands of such requests are sent toward any service. The system would become unresponsive and go into a Denial of Service (DoS) state. The regular expression illustrated in FIG. 7 worked properly for a valid set of inputs, as illustrated in FIG. 6. However, when an input with evil intent is provided, the number of backtracking (sometimes infinite) causes huge delays in response.

In an example embodiment, the decision maker module 213 receives outputs from the intelligent analyzer module 211 and determines the regular expression vulnerability assessment associated with the plurality of regular expressions based on the outputs, using policies applied to the outputs. In an example embodiment, the policies are stored in the source code repository 101. The decision maker module 213 may determine whether to treat any given output as a failure and raise a red flag for the associated regular expression. The decision maker module 213 may also determine a degree of deviation for a particular regular expression. The decision maker module 213 may also determine a degree of deviation associated with the plurality of regular expressions. The determinations are performed based on the policies stored in the source code repository 101 and a manifest shared by the CDN analyzer. In an example embodiment, the CDN analyzer acts as a bridge between the regex engine system 106 and a backend server. The CDN analyzer updates the backend server regarding the inputs generated by the test input generator module 217.

In an example embodiment, the decision maker module 213 determines that at least one of the plurality of regular expressions is vulnerable to a denial of service attack, and provides these identified regular expressions with a failed regular expression vulnerability assessment.

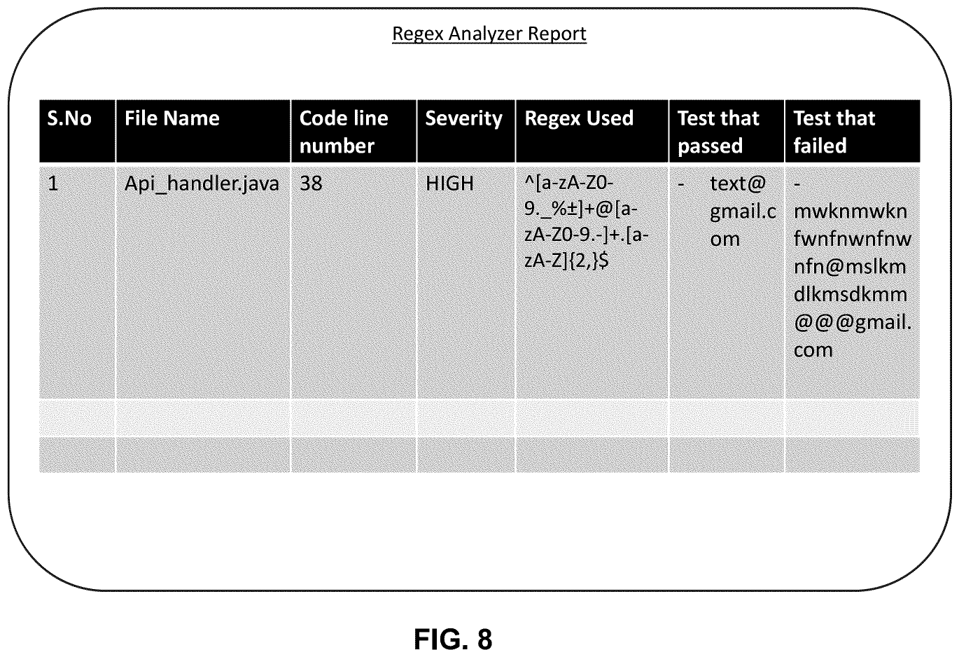

At 406, the regex engine system 106 generates a regular expression vulnerability assessment report comprising the regular expression vulnerability assessment, and propagates the report. The report comprises a list of evil regular expressions that are vulnerable to Regular Expression Denial of Service (REDOS) attacks. REDOS is a type of attack that exploits the vulnerabilities in regular expressions in applications. Regular expressions are required for both business and application needs. The decisions can then be made whether to fix the source code to remove these evil regular expressions, or add additional validation in the front end (i.e., the client side). In an example embodiment, the regex engine system 106 presents the results data (i.e., the regular expression vulnerability assessment report) in the framework UI portal with a respective state diagram. The regex engine system 106 provides the state diagram with the vulnerabilities, along with the time factor reporting for an exact understanding of the identified issues. FIG. 8 illustrates an example regular expression vulnerability assessment report, titled Regex Analyzer Report produced by the regex engine system 106.

In an example embodiment, the regex engine system 106 transmits, the source code to a build stage in the CI/CD pipeline system 105. As illustrated in FIG. 5, when the regex engine system 106 has completed identifying regular expressions in the source code, and more specifically, identifying evil regular expressions, and then generating the regular expression vulnerability assessment report, the regex engine system 106 transmits the source code to the next stage in the CI/CD pipeline system 105, in this case, the build trigger stage.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a method and a system for providing a regex engine system. These and other embodiments can effectively identify evil regular expressions relative to conventional approaches. For example, embodiments disclosed herein continually scan source code to find the implemented regular expression and evil regular expressions. Embodiments disclosed herein validate regular expressions to ensure proper implementation of the regular expressions in source code. Embodiments disclosed herein capture information regarding the amount of damage that can be done with a given regular expression. Embodiments disclosed herein provide a framework to identify evil regular expressions in source code that has been recently checked into a CI/CD pipeline system, where the framework performs a deep search and analyzes various design patterns to understand the threat that evil regular expressions can cause. Embodiments disclosed herein provide a method to auto-generate sample inputs for testing the regular expressions for fast fail approach using boundary value analysis technique. Embodiments disclosed herein use machine learning to auto generate the sample inputs for testing the regular expressions. Embodiments disclosed herein provide a tool that pre-empts regular expression Denial of Service (REDOS) attacks.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

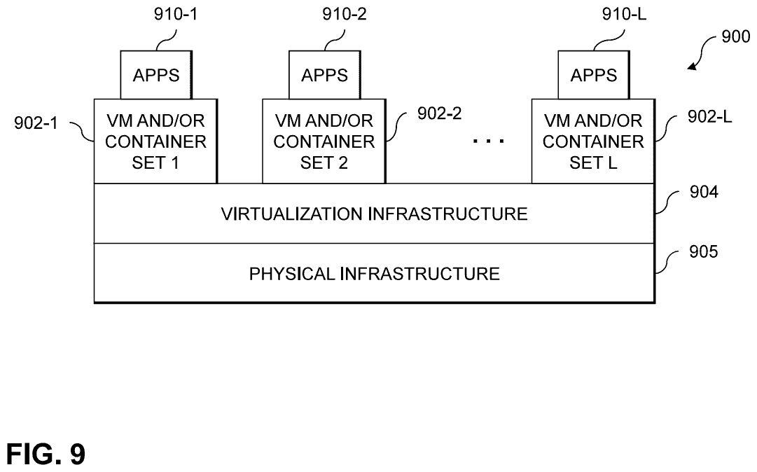

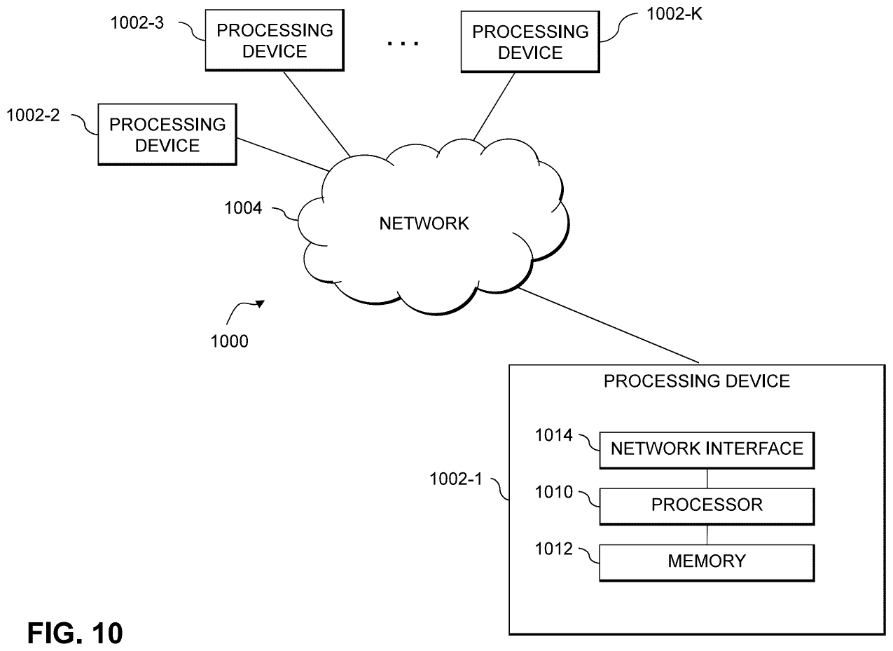

Illustrative embodiments of processing platforms will now be described in greater detail with reference to FIGS. 9 and 10. Although described in the context of the information processing system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, where the hypervisor platform has an associated virtual infrastructure management system. The underlying physical machines comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10. The processing platform 1000 in this embodiment comprises a portion of the information processing system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a microcontroller, an application-specific integrated circuit (ASIC), a field-programmable gate array (FPGA) or other type of processing circuitry, as well as portions or combinations of such circuitry elements.

The memory 1012 comprises random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
triggering, by a Continuous Integration/Continuous Delivery (CI/CD) pipeline system, a regex engine system to scan source code;
scanning, by the regex engine system, the source code for a plurality of regular expressions;
determining, by the regex engine system, a regular expression vulnerability assessment associated with the plurality of regular expressions; and
generating, by the regex engine system, a regular expression vulnerability assessment report comprising the regular expression vulnerability assessment, wherein the method is performed by at least one processing device comprising a processor coupled to a memory.

2. The method of claim 1 further comprising:
transmitting, by the regex engine system, the source code to a build stage in the CI/CD pipeline system.

3. The method of claim 1 wherein triggering, by the CI/CD pipeline system comprises:
receiving, by the regex engine system, the source code from a source code repository associated with the CI/CD pipeline system.

4. The method of claim 1 wherein scanning, by the regex engine system, the source code comprises:
compiling, by a collector module, source code information, from a source code repository to identify the source code to be scanned by the regex engine system, wherein the regex engine system comprises the collector module.

5. The method of claim 1 wherein scanning, by the regex engine system, the source code comprises:
scanning, by a search engine, the source code to identify the plurality of regular expressions in the source code, wherein the regex engine system comprises the search engine.

6. The method of claim 1 wherein scanning, by the regex engine system, the source code comprises:
receiving, by a knowledge lake, scanning requirements for the source code, wherein the regex engine system comprising the knowledge lake.

7. The method of claim 6 wherein the knowledge lake comprises information about regular expressions identified in previously scanned source code.

8. The method of claim 6 wherein a test input generator receives, from the knowledge lake, information about regular expressions identified in previously scanned source code.

9. The method of claim 6 further comprising:
transmitting, from a test input generator to the knowledge lake, regular expression test inputs with which to validate the plurality of regular expressions for the regular expression vulnerability assessment, wherein the test input generator generates the test inputs based on machine learning inputs from a learning engine, wherein the regex engine system comprises the test input generator and the learning engine.

10. The method of claim 9 wherein transmitting, from the test input generator to the knowledge lake, regular expression test inputs comprises:
for each regular expression in the plurality of regular expressions:
generating, by the test input generator at least one set of passing test inputs for the each regular expression that match regular expression validation criteria, wherein the at least one set of passing test inputs, when applied to the each regular expression pass the regular expression validation criteria;
generating, by the test input generator at least one set of failing test inputs for the each regular expression that match the regular expression validation criteria, wherein the at least one set of failing test inputs, when applied to the each regular expression fail the regular expression validation criteria; and
generating, by the test input generator at least one set of boundary test inputs for the each regular expression that match the regular expression validation criteria, wherein the at least one set of boundary test inputs, when applied to the each regular expression signal a potential catastrophic failure according to the regular expression validation criteria.

11. The method of claim 9 further comprising:
Compiling, by the learning engine, regular expression data from the plurality of regular expressions and regular expression vulnerabilities associated with the plurality of regular expressions.

12. The method of claim 1 wherein determining, by the regex engine system, the regular expression vulnerability assessment comprises:
identifying, by the regex engine system as part of the regular expression vulnerability assessment, that at least one of the plurality of regular expressions comprises infinite backtracking.

13. The method of claim 1 determining, by the regex engine system, the regular expression vulnerability assessment comprises:
validating, by an intelligent analyzer module, the plurality of regular expressions using regular expression test inputs provided by a test input generator module, wherein the regex engine system comprises the intelligent analyzer module and the test input generator module.

14. The method of claim 13 further comprising:
prioritizing, by the intelligent analyzer module, the regular expression test inputs to detect fast-fail regular expression test inputs, wherein the intelligent analyzer module employs a conformal prediction machine learning model.

15. The method of claim 13 wherein validating, by the intelligent analyzer module, the plurality of regular expressions comprises:
for each regular expression in the plurality of regular expressions:
applying, by the intelligent analyzer module, at least one set of passing test inputs, to the each regular expression;
applying, by the intelligent analyzer module, at least one set of failing test inputs, to the each regular expression; and
applying, by the intelligent analyzer module, at least one set of boundary test inputs, to the each regular expression; and
transmitting results of at least one of the applying passing test inputs, failing test inputs and boundary test inputs to the decision maker module.

16. The method of claim 15 further comprising:
determining a degree of deviation from a regular expression execution time for a subset of the plurality of regular expressions.

17. The method of claim 13 further comprising:
receiving, by a decision maker module, outputs from the intelligent analyzer module; and
determining, by the decision maker module, the regular expression vulnerability assessment associated with the plurality of regular expressions based on the outputs, using policies applied to the outputs.

18. The method of claim 17 further comprising:
determining, by the decision maker module that at least one of the plurality of regular expressions is vulnerable to a denial of service attack; and
providing the at least one of the plurality of regular expressions with a failed regular expression vulnerability assessment.

19. A system comprising:
at least one processing device comprising a processor coupled to a memory;
the at least one processing device being configured:
to trigger, by a Continuous Integration/Continuous Delivery (CI/CD) pipeline system, a regex engine system to scan source code;
to scan, by the regex engine system, the source code for a plurality of regular expressions;
to determine, by the regex engine system, a regular expression vulnerability assessment associated with the plurality of regular expressions; and
to generate, by the regex engine system, a regular expression vulnerability assessment report comprising the regular expression vulnerability assessment.

20. A computer program product comprising a non-transitory processor-readable storage medium having stored therein program code of one or more software programs, wherein the program code when executed by at least one processing device causes said at least one processing device:
to trigger, by a Continuous Integration/Continuous Delivery (CI/CD) pipeline system, a regex engine system to scan source code;
to scan, by the regex engine system, the source code for a plurality of regular expressions;
to determine, by the regex engine system, a regular expression vulnerability assessment associated with the plurality of regular expressions; and
to generate, by the regex engine system, a regular expression vulnerability assessment report comprising the regular expression vulnerability assessment.
